(19) United States
(12) Patent Application Publication
(10) Pub. No.: US 2016/0087424 A1
(43) Pub. Date: Mar. 24, 2016

(54) POWERLINE SURGE PROTECTION

(71) Applicant: Nidec Motor Corporation, St. Louis, MO (US)

(72) Inventor: James L. Skinner, Collinsville, KS (US)

(21) Appl. No.: 14/494,333

(22) Filed: Sep. 23, 2014

(51) Int. Cl. H02H 7/085; H01T 4/02

(52) U.S. Cl. CPC H02H 7/0855; H01T 4/02

(57) ABSTRACT

A motor drive for an electric machine configured to withstand higher voltages without breakdown and without substantially raising maximum voltage during high voltage surges. The motor drive may include a live line, a second line, a ground line, a capacitor, a surge protector, and a load electrically-coupled with the live line, the second line, and the ground line. The capacitor may be coupled between the load and the second line. The surge protector may have a first varistor, a gas discharge tube (GDT), and a resistor. The GDT may be non-conductive below a trigger voltage and is conductive above the trigger voltage. The first varistor and the GDT may be connected in series between the live line and the ground line and/or the second line and the ground line, and the resistor may extend across a spark gap of the GDT.

### BACKGROUND

Appliances, such as dishwashers, washing machines, clothes dryers, and the like are typically driven by electric motors. A motor drive provides power from a source, such as a household power outlet, to the electric machine. The household power outlet typically supplies NC power at a line voltage (such as 115V) and a line frequency (such as 60 Hz).

Line voltage transients, or surges, can occur due to lightning strikes and other sources. Voltage surges may reach up to 6,000V. Residential electrical appliances are designed to withstand these power surges. Some motor drives incorporate surge protection circuits that limit damage due to power surges. One surge protection circuit includes a line to a neutral metal oxide varistor (MOV) and a neutral to ground MOV in the motor drive circuitry. The MOVs clamp the surge voltages. The surge protection circuit may also include a line to ground MOV.

Appliances typically undergo insulation testing, which requires 1,200V to 1,800V to be applied to the electric machine through the motor drive. This high voltage causes conduction of traditional MOV-type surge protectors that are incorporated in the motor drive which prevents satisfactory testing. As a result, a jumper circuit is used during insulation testing to disconnect the surge protection circuit. The requirement of connecting and disconnecting the jumper circuit adds additional cost and time to the manufacturing process.

Another surge protection circuit employs spark gaps in the circuit board of the motor drive. The breakdown voltage of spark gaps, however, is adversely impacted by dirt and humidity variations. Spark gaps are further subject to carbon accumulation and metal displacement from electrodes into the spark gap area, which limits their useful life.

Yet another circuit protection circuit includes a gas tube in series with a MOV. The gas tube spark gap allows insulation testing with high voltage without any disconnection of surge protection circuits. The gas tube breaks down or conducts during a surge and allows the MOV to clamp surge voltage to protect other circuitry. However, there is a limited selection of gas tube voltages for use with different line voltages. For example, a 460V line input unit requires a test voltage greater than the minimum breakdown voltage of the gas tube for a one-second test. The slightly-lower-voltage 60 second test may be possible, but the additional time required by this test limits production output and may also present an additional safety risk. Higher voltage gas tubes are not as readily available nor economical, and have higher breakdown voltages, which further stresses the protected circuit. Thus there is a need for improved powerline surge protection.

### SUMMARY

An embodiment of the present invention is a motor drive for an electric machine configured to withstand higher voltages without breakdown and without substantially raising maximum voltage during high voltage/high current surges. The motor drive may include at least one live line, a second line, a ground line, a capacitor, a surge protector, and a load electrically-coupled with the live line, the second line, and the ground line. The capacitor may be coupled between the load and the second line.

The surge protector may have a metal-oxide varistor (MOV), a gas discharge tube (GDT), and a resistor. The GDT may be non-conductive below a trigger voltage and conductive above the trigger voltage. The MOV and the GDT may be connected in series with each other and the resistor may be connected in parallel with the GDT. For example, the MOV and the GDT may be connected in series between the second line and the ground line, and the resistor may extend across a spark gap of the GDT.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present invention will be apparent from the following detailed description of the preferred embodiments and the accompanying drawing figures.

### BRIEF DESCRIPTION OF THE DRAWING FIGURES

Embodiments of the present invention are described in detail below with reference to the attached drawing figures, wherein:

FIG. 1 is a schematic view of an electric machine with a motor drive constructed in accordance with an embodiment of the present invention;

FIG. 2 is a schematic view of the motor drive of FIG. 1; and

FIG. 3 is a schematic view of a motor drive constructed in accordance with an alternative embodiment of the present invention.

The drawing figures do not limit the present invention to the specific embodiments disclosed and described herein. The drawings are not necessarily to scale, emphasis instead being placed upon clearly illustrating the principles of the invention.

### DETAILED DESCRIPTION

The following detailed description of the invention references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The following detailed description is, therefore, not to be taken in a limiting sense. The scope of the present invention is defined only by the appended claims, along with the full scope of equivalents to which such claims are entitled.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the present technology can include a variety of combinations and/or integrations of the embodiments described herein.

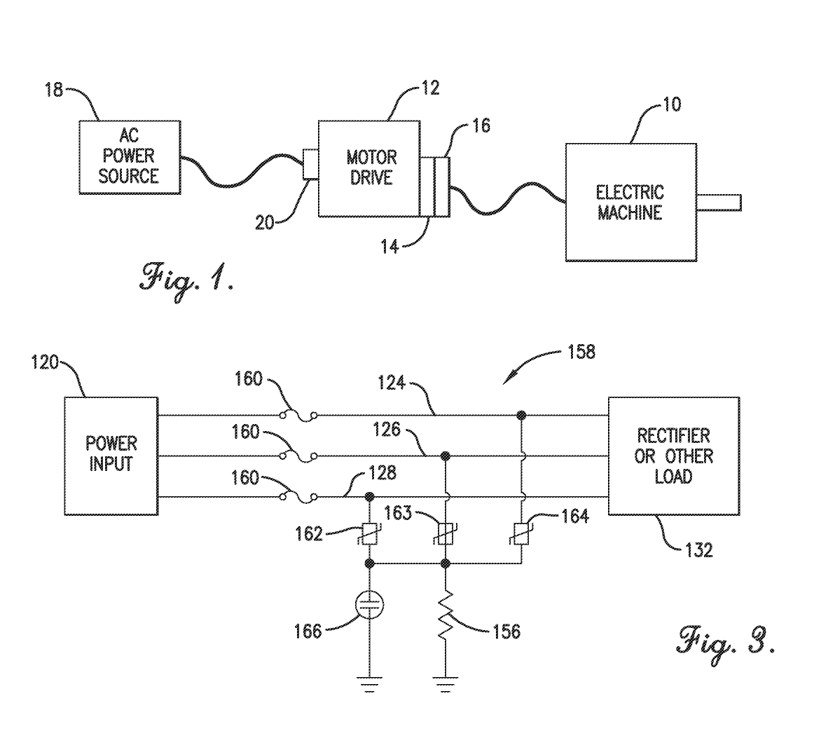

As illustrated in FIG. 1, the present invention is a motor drive 12 for an electric machine 10. In one embodiment, the electric machine 10 is a direct-current (DC) or alternating-current (AC), fractional horsepower (HP) electric machine. The electric machine 10 is powered by a voltage signal (AC or DC) and generates power under 1 HP. While a fractional Hp electric machine is illustrated and described herein, other types of electric machines may be used.

The voltage signal to the electric machine 10 may be supplied by the motor drive 12. A motor drive connector 14 associated with the motor drive 12 may be connected to an electric machine connector 16 associated with the electric machine 10. An alternating-current (AC) power source 18 may provide an AC voltage signal to the motor drive 12 through a power input 20. The motor drive 12 may be configured to convert the AC voltage signal to a DC voltage signal to power the electric machine 10, in the case of a DC electric machine.

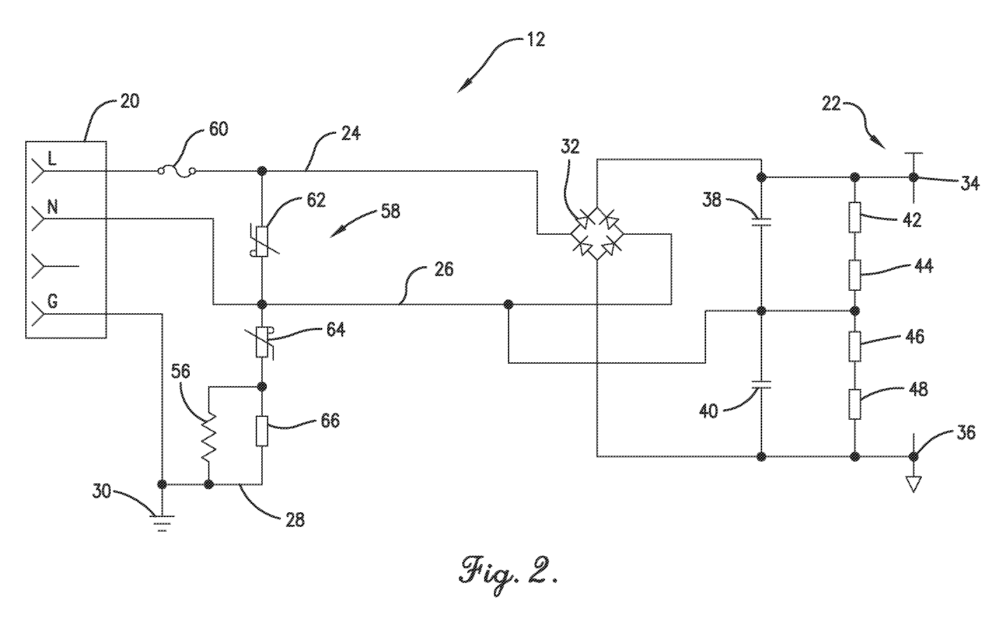

As illustrated in FIG. 2, the motor drive 12 may include the power input 20, a power output or voltage bus 22, a load such as a voltage rectifier 32, capacitors 38, 40, resistors 42, 44, 46, 48, and a surge protector 58. The power input 20 includes a live line 24, a second line 26, and a ground line 28. The second line 26 may be a live line or a neutral line, depending on the application. For example, in the case of a 115V application, the second line 26 may be a neutral line, and in the case of a 230V application, the second line 26 may be a live line. Power may be supplied to the voltage bus 22 via the live and second lines 24 and 26. The ground line 28 may be connected to a safety ground 30. The voltage rectifier 32 may convert the AC voltage signal from the power input 20 to the DC voltage signal. In some embodiments of the invention, the voltage rectifier 32 may be a doubler-type voltage rectifier or a standard full wave-type voltage rectifier. However, any load may replace the voltage rectifier 32 without departing from the scope of the invention.

The DC voltage signal from the voltage rectifier 32 may be supplied to the voltage bus 22. The voltage bus 22 may include a voltage output terminal 34 and a common return terminal 36. The voltage bus 22 may communicate with the motor drive connector 14 to supply the DC voltage signal to the electric machine 10 through the electric machine connector 16. Capacitors 38 and 40 store charge. Resistors 42, 44, 46 and 48 equalize stored charges in the capacitors 38 and 40. While four resistors are shown, additional or fewer resistors may be used.

The surge protector 58 may be configured to prevent excessive voltage from damaging the components of the motor drive 12 and the electric machine 10. Furthermore, the surge protector 58 may be configured to enable insulation testing without modification to the motor drive 12, while protecting the motor drive 12 and electric machine 10 from voltage surges. The surge protector 58 may include a fuse 60, at least one metal-oxide varistor (MOV) 62, 64, a gas-discharge tube (GDT) 66, and a resistor 56 or resistors electrically connected in parallel with the GDT 66. In some embodiments of the invention, a compensation capacitor (not shown) may be electrically connected in parallel to the GDT 66 and the resistor 56 to compensate for any capacitance on the MOVs 62, 64 and to reduce noise susceptibility in the surge protector 58.

As illustrated in FIG. 2, a first MOV 62 may bridge the live line 24 and the second line 26. Furthermore, a second MOV 64 and the GDT 66, connected in series with each other, may bridge the second line 26 and the ground line 28. The MOVs described herein may be replaced with other varistors without departing from the scope of the invention. Furthermore, MOV 62 may be omitted or another MOV may be added in series with the GDT without departing from the scope of the invention.

In some embodiments of the invention, as in FIG. 2, the fuse 60 may be located in the live line 24. The fuse 60 provides over current protection by blowing and creating an open circuit when current therethrough exceeds a rated current of the fuse 60. The open-circuit prevents power flow through the motor drive 12 and prevents operation of the electric machine 10.

The MOVs 62 and 64 limit surge voltages by clamping them, as will be described. The MOVs 62 and 64 provide a variable resistance that is based on the voltage across each. Each MOV 62 and 64 includes a corresponding voltage threshold or break-over voltage. Exemplary break-over voltages for the MOV's 62 and 64 are between approximately 400V and 800V. When voltage across an MOV is less than its break-over voltage, that MOV has a high resistance that limits current flow. When the voltage across an MOV is above its break-over voltage, that MOV has a relatively low resistance that limits the voltage.

The GDT 66 also limits voltage. The GDT 66 includes an inert gas within a ceramic housing that is capped by electrodes (not shown). The GDT 66 has a trigger voltage, above which it becomes conductive. An exemplary trigger voltage is between 3000V and 3500V. For example, when the voltage across the GDT 66 is below the trigger voltage, the GDT 66 is non-conductive (i.e., no current flow therethrough). When the voltage across the GDT 66 is above the trigger voltage, the GDT 66 is conductive and current flows therethrough. Once the GDT 66 is triggered, it becomes highly conductive. This further limits the voltage and reduces the possibility of damage from the voltage surge. The GDT 66 may form or comprise a spark gap, and the resistor 56 may be placed across this spark gap.

Specifically, the resistor 56 may be connected in parallel to the GDT 66 and in series with the MOVs 62, 64. The resistor may comprise a single resistor or a plurality of resistors in series with each other and parallel to the GDT 66. The resistor 56 may have a resistance of several mega ohms, or any resistance large enough to create a small amount of current through the MOVs. The amount of resistance provided by resistor 56 may, for example, be just enough to get some voltage drop across the MOVs, causing some current to flow through the surge protector 58 at all times. The specific values chosen for the resistor 56 may depend on line voltage; the higher the line voltage is, the higher resistance needed for resistor 56.

The resistor 56 may cause a voltage drop across one or both of the MOVs 62, 64. Therefore, the inclusion of the resistor 56 raises the voltage that can be applied to the MOV 64/GDT 66 combination without breakdown by the amount of voltage drop across the MOV 64. For example, if a 3 Mega ohm resistor is used at 3,000 V, 1 mA may flow. At 1 mA, an EPCOS s20k300 or equivalent MOV may have a voltage drop of 470V (+/−10%).

In use, under normal operating conditions, the AC voltage signal from the power source 18 may be supplied to the voltage rectifier 32 through the live and second lines 24, 26. The voltage rectifier 32 may convert the AC voltage signal to the DC voltage signal, which is supplied to the voltage bus 22. The DC signal from the voltage bus may drive the electric machine 10 through the connectors 14 and 16.

Prior to entering the marketplace, the motor drive 12 may undergo insulation testing or high potential (hi-pot) testing to insure component integrity. Hi-pot testing generally requires applying an AC voltage signal to the power input 20 at approximately twice the line voltage plus 1000V. The line voltage can be 115V, or other voltage levels. In applications including a doubler-type voltage rectifier, the line voltage is typically 115V. Therefore, during hi-pot testing, 1230V (i.e., 2*115V+1000V) to as much as 1460V (i.e., 2*230V+1000V) can be supplied through the motor drive 12. These voltages may be AC voltages, however DC voltages equal to the peak (1.414×AC voltage) may be used.

In one test, the hi-pot testing includes application of the amplified voltage through the motor drive 12 for a 60 second period. However, in hi-pot testing, the testing time can be reduced by increasing the applied voltage. More particularly, an increase of approximately 20% in the voltage reduces the testing time to approximately 1 second. Therefore, in the lightest case, 1230V is applied through the motor drive 12 (115V application using 60 second test time). Typically in the heaviest case, up to approximately 1800V is applied through the motor drive 12 (230V application using 1 second test time).

When hi-pot testing, the live and second lines 24, 26 may be interconnected by a jumper (not shown). An amplified AC voltage may be applied between the combined live line 24 and second line 26 and ground 30. The amplified voltage ranges between approximately 1230V and 1800V, depending on the application type and testing time. The amplified voltage signal is supplied to the voltage rectifier 32 or another load through the combined live and second lines 24, 26. For higher line voltages, even higher test voltages may be used.

Neither the MOV 62 nor the series MOV 64 and GDT 66 of FIG. 2 should affect the application of the amplified voltage during hi-pot testing. Because the live and second lines 24 and 26 are combined, opposite ends of the MOV 62 are at the same voltage potential and there is no voltage drop across the MOV 62. Therefore, the break-over voltage of the MOV 62 is not reached. Although the break-over voltage of the MOV 64 would be achieved during hi-pot testing, the trigger voltage of the GDT 66 is not achieved. Therefore, the GDT 66 remains non-conductive and does not provide a path to ground 30.

However, in some situations where a voltage used during hi-pot testing is near, equal to, or greater than the trigger voltage of the GDT 66, the inclusion of the resistor 56, as illustrated in FIG. 2, may create a voltage drop of several hundred volts across the MOV 64, such that less of the hi-pot testing voltage is applied to the GDT 66. In this way, a higher hi-pot testing voltage may be used without the GDT 66 being triggered. The resistance of the resistor 56 may be selected such that the test voltage minus a voltage drop across the MOV 64 equals a value less than the trigger voltage of the GDT 66.

A voltage surge from the power source 18 induces operation of the motor drive 12 under a surge condition. A lightning strike or other event can induce a voltage surge up to approximately 6000V. Additionally, surges can occur in one of two modes, a common mode and a differential mode. In the common mode, the voltage surge is applied through the motor drive 12 via both the live and second lines 24 and 26 (i.e., live and second lines are combined). In the differential mode, the voltage surge is applied through the motor drive 12 via the live line 24, as would occur during normal operation.

During a common mode surge, the MOV 64 and the GDT 66, as illustrated in FIG. 2, limit the voltage through the motor drive 12 and divert excess voltage to ground 30. More particularly, as the voltage surges, the voltage across the MOV 64 exceeds the break-over voltage and the voltage across the GDT 66, even with the resistor 56 in parallel therewith, exceeds the trigger voltage. As a result, the GDT 66 is conductive and diverts the excess voltage to ground 30. During a differential mode surge, the MOV 62 limits the voltage to the motor drive 12, clamping the excess voltage as previously described. More particularly, as the voltage surges, the voltage across the MOV 62 achieves its break-over voltage.

Although the present description and figures illustrate the MOV 64 and the GDT 66 connected in series between the second line 26 and the ground line 28, it is anticipated that the MOV 64 and the GDT 66 can be connected in series between the live line 24 and the ground line 28. The surge protector 58 provides similar surge protection of the motor drive 12 in this alternative configuration.

In some alternative embodiments of the invention, as illustrated in FIG. 3, a surge protector 158, similar to the surge protector 58 described above, may be configured for a three-phase circuit having three wires representing three phases 124, 126, 128 connecting a power input 120 to a rectifier 132 or other load requiring a three-phase power signal. Each of the lines 124, 126, 128 may include its own fuse 160 in series therewith. The surge protector 158 may also include three MOVs 162, 163, 164 connected in series with each of the lines 124, 126, 128 and in series with one GDT 166, similar to the GDT 66 described above. The surge protector 158 may also comprise a resistor 156 connected in parallel with the GDT 166 and in series with the MOVs 162, 163, 164, as illustrated in FIG. 3. The three-phase circuit embodiment may also use several line-to-line MOVs and one MOV/gas tube/resistor combination similar to the MOV 64, GDT 66, and resistor 56 arrangement illustrated in FIG. 2

Advantageously, the surge protector 58, by using the resistor 56 (or the resistor 156) connected in parallel with the GDT 66 (or the GDT 166), allows for increased voltage capability of spark gaps for higher voltage applications without requiring the use of different GDTs. In some embodiments of the invention, the resistor 56 may even include a variable resistor so that the surge protector 58 may be customized for particular applications.

Although the invention has been described with reference to the preferred embodiment illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

1. A motor drive for an electric machine, the motor drive comprising:
a plurality of electrically-conductive lines configured to be electrically coupled with an electrical load; and
a surge protector including:
a varistor,
a gas discharge tube (GDT) having a spark gap, wherein the GDT is non-conductive below a trigger voltage and conductive above the trigger voltage, and
at least one resistor electrically coupled in parallel to the GDT, thereby extending across the spark gap of the GDT,
wherein the varistor and the GDT are connected in series between one of the electrically-conductive lines and an electrical ground.

2. The motor drive of claim 1, wherein the varistor has a voltage threshold that is less than a hi-pot test voltage and less than the trigger voltage, wherein the hi-pot test voltage is less than the trigger voltage, wherein the trigger voltage is less than a surge voltage.

3. The motor drive of claim 1, wherein the electrically-conductive lines include a live line, a second line that is neutral or live, and a ground line.

4. The motor drive of claim 1, wherein at least some of the electrically-conductive lines transmit different individual phases of a three phase circuit signal.

5. The motor drive of claim 4, including additional varistors, such that at least one varistor is connected between each of the electrically-conductive lines and the GDT.

6. The motor drive of claim 1, wherein the varistor has a voltage threshold that is less than a hi-pot test voltage and less than the trigger voltage, wherein the hi-pot test voltage is equal to or greater than the trigger voltage, wherein the trigger voltage is less than a surge voltage, wherein the resistance of the resistor is selected such that the test voltage minus a voltage drop across the varistor equals a value less than the trigger voltage of the GDT.

7. The motor drive of claim 1, wherein the varistor is a metal oxide varistor (MOV).

8. A motor drive for an electric machine, the motor drive comprising:
a live line;
a second line;
a ground line;
a load electrically coupled with the live line, the second line, and the ground line; and
a surge protector including:
a varistor,
a gas discharge tube (GDT) having a spark gap, wherein the GDT is non-conductive below a trigger voltage and that is conductive above the trigger voltage, and
a resistor electrically coupled in parallel with the GDT, thus extending across the spark gap of the GDT,
wherein the varistor and the GDT are connected in series between the live line and the ground line or the second line and the ground line.

9. The motor drive of claim 8, wherein the trigger voltage is greater than a hi-pot test voltage.

10. The motor drive of claim 8, wherein the varistor has a voltage threshold that is less than a hi-pot test voltage and less than the trigger voltage, wherein the hi-pot test voltage is more than the trigger voltage, wherein the trigger voltage is less than a surge voltage.

11. The motor drive of claim 8, wherein the second line is a neutral line.

12. The motor drive of claim 8, wherein the second line is another live line.

13. The motor drive of claim 8, further comprising a capacitor coupled between the load and the second line.

14. The motor drive of claim 8, wherein the load comprises a rectifier.

15. The motor drive of claim 8, wherein the varistor is a metal oxide varistor (MOV).

16. A motor drive configured for an electric machine, the motor drive comprising:
a live line;
a second line;
a ground line;
a load electrically coupled with the live line, the second line, and the ground line; and
a surge protector including:
a metal oxide varistor (MOV),
a gas discharge tube (GDT) having a spark gap, wherein the GDT is non-conductive below a trigger voltage and that is conductive above the trigger voltage, and
a resistor electrically coupled in parallel to the GDT, thereby extending across the spark gap of the GDT,
wherein the MOV and the GDT are connected in series between the live line and the second line or the second line and the ground line.

17. The motor drive of claim 16, wherein the MOV has a voltage threshold that is less than a hi-pot test voltage and less than the trigger voltage, wherein the hi-pot test voltage is more than the trigger voltage, wherein the trigger voltage is less than a surge voltage.

18. The motor drive of claim 16, wherein the second line is a neutral line or another live line.

19. The motor drive of claim 16, further comprising a capacitor coupled between the load and the second line.

20. The motor drive of claim 16, wherein the load comprises a rectifier.
